(19) United States
(12) Patent Application Publication
(10) Pub. No.: US 2018/0113904 A1
(43) Pub. Date: Apr. 26, 2018

(54) Extreme Value Estimation for Query Optimization in Analytical Databases

(71) Applicant: International Business Machines Corporation, Armonk, NY (US)

(72) Inventor: Andreas Brodt, Gerlingen (DE)

(21) Appl. No.: 15/298,482

(22) Filed: Oct. 20, 2016

(51) Int. Cl. G06F 17/30

(52) U.S. Cl. CPC G06F 17/30463; G06F 17/30289

(57) ABSTRACT

A mechanism is provided for preparing a query execution plan in a database management system. A determination is made of set of the query predicates in a query comprising query predicates associated with respective attributes of a set of attributes to evaluate using attribute value information. The set of query predicates having associated attributes of at least one attribute. For each query predicate, the attribute value information of the data table is queried for determining a set of the data blocks to be scanned. For each query predicate of the set of query predicates, the smallest minimum value and the largest maximum value of the associated attribute in all data blocks to be scanned are determined. The smallest minimum value and the largest maximum value of the associated attribute may be used in query optimization for resulting in the query execution plan for the query.

### BACKGROUND

The present invention relates to the field of digital computer systems, and more specifically, to a method for preparing a query execution plan in a database management system.

Query performance in analytical databases, much more than in online transaction processing (OLTP) systems is highly dependent on accurate selectivity estimation for the query optimizer. This is because typical analytical queries do not include point queries. By contrast, they process large fractions of very large tables and include joins with many other tables before they finally reduce the result set by computing an aggregate. Bad plan decisions, such as choosing the wrong join order, makes the difference between query runtimes of seconds or months in these systems. In order to make the right plan decisions, it is crucial for the query optimizer to accurately estimate the selectivity of parts of a query (e.g., predicates, joins, groupings, etc.).

### SUMMARY

Various embodiments provide a method for preparing a query execution plan in a database management system, computer system and computer program product as described by the subject matter of the independent claims. Advantageous embodiments are described in the dependent claims. Embodiments of the present invention can be freely combined with each other if they are not mutually exclusive.

In one illustrative embodiment, a method, in a data processing system, is provided for preparing a query execution plan in a database management system, where a data table comprising a set of attributes and data records is provided, attribute value information being provided for data blocks of the data table, the attribute value information comprising at least a minimum value representing the smallest value of at least one of the attributes in the set of attributes and a maximum value representing the largest value of the at least one attribute of the set of attributes. The illustrative embodiment receives a query against the data table, the query comprising query predicates associated with respective attributes of the set of attributes. The illustrative embodiment determines a set of the query predicates in the query to evaluate using the attribute value information, the set of query predicates having associated attributes of the at least one attribute. The illustrative embodiment queries, for each query predicate of the set of query predicates, the attribute value information of the data table for determining a set of the data blocks to be scanned. The illustrative embodiment determines, for each query predicate of the set of query predicates, the smallest minimum value and the largest maximum value of the associated attribute in all data blocks to be scanned. The illustrative embodiment uses the smallest minimum value and the largest maximum value of the associated attribute in query optimization, resulting in the query execution plan for the query.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 represents a computerized system, suited for implementing one or more method steps as involved in the present disclosure; and

FIG. 2 is a flowchart of a method for preparing a query execution plan in a database management system.

### DETAILED DESCRIPTION

The descriptions of the various embodiments of the present invention will be presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The attribute value information may be descriptive of the at least one attribute. Using the attribute value information a preselection of data blocks of the data table may be performed before scanning the preselected data blocks. The attribute value information may comprise information or metadata on the attribute that allows such a preselection. For example, the maximum and the minimum attribute values of the attribute define a first range of values of the attribute in a respective data block. For example, a received data query may require a second range of values of the attribute. The processing of the data query may comprise selecting data blocks of the data table whose respective first range overlap with the second range and processing those selected data blocks (that forms a scan list).

A query predicate may be an element of a search condition that expresses or implies a comparison operation. The query predicate may comprise a selection expression. The selection expression may be created using an operator. The selection expression may form a so-called relational expression or a condition. The selection expression may consist of a data item or attribute, an operator or negation operator, and a value.

The term “operator” as used herein refers to an operator that tests values or range of values against an attribute. The operator may for example comprise a relational operator that tests or defines a relation or condition between two entities including at least the attribute. These include equality (e.g., attribute=5) and inequalities (e.g., attribute ≥3).

For example, the received query may comprise a statement for selecting rows of the data table 127 that meet specified criteria. The criteria may be expressed in the form of predicates. The received query may have one or more query predicates on at least the attribute 131B. For example, a query predicate may comprise a constant equality predicate (e. g. “AGE=17”).

According to one embodiment, the method further comprises: providing patterns of query predicates, each pattern being associated with a respective category; parsing the query into constituent parts; determining that a constituent part parsed from the query corresponds to at least part of a pattern of the patterns; associating the category that is associated with the pattern with the query.

The category may for example be equality or inequality predicate category. For example, in case the category is an inequality predicate, the pattern associated with the query may comprise signs “<”, “>”, or a combinations thereof (e.g. that express more complex predicates involving complex comparisons or the like).

The term “query plan” or “query execution plan” to an ordered set of one or more steps used to access data in a database system. For example, a query optimizer may be configured so as to use the guaranteed bound to provide a query execution plan. The guaranteed bound may provide an additional constraint for the query optimizer to choose or to provide an improved and most efficient execution plan in term of processing time and processing resources. The above features may thus have the advantage of saving processing resources that would otherwise be required when a processing plan is generated without that additional constraint.

The query optimizer may have multiple query plans and may choose one of them based on a cost model. An example cost model may require as input the cardinality or number of rows or any other parameter that can be determined using the smallest min and the largest max. That parameter may be evaluated by a respective heuristic that may use the smallest min and the largest max to determine the parameter value.

Without having a guaranteed bound (e.g. by having an under- or over-estimated bound) a chosen or a selected execution plan may not be relied on as it may be inappropriate for the system executing the query. The attribute value information once created at time t0 has values the minimum and maximum values that reflect at time t0 the current minimum and maximum values; however, at time t1>t0 it may happen that changes occur (the changes comprise a deletion of one or more records from a data block) e.g. deletion of the record that has the maximum value. In this case, the minimum and maximum values determined at time t0 constitute a guaranteed lower and upper bound at time t1.

For example, having a low cardinality or a low number of rows (i.e. the guaranteed bound is smaller than a predefined threshold) means that a full table scan may be faster than using an index. The query optimizer may thus be configured to compare the guaranteed bound with the predefined threshold and based on the comparison the query optimizer may select or not an execution plan that would perform a full scan of the subset of data blocks.

The present method may be advantageous in that it may avoid executing database queries on a small sample of the data to obtain just-in-time (JIT) statistics that reflect the conditional probabilities relevant to the query as those “mini query” to compute the JIT statistics imposes certain costs in term of resources. Thus, the extremum values available to the query optimizer are accurate. This may lead to better plan decisions and thus to improved query performance.

Another advantage may be described by the following scenario of conjunctive query predicates as in the following query:
SELECT * FROM mytable
WHERE a=100 AND b>20

To estimate the selectivity of this predicate well, the query optimizer must know the extremum values in column b of all rows that have a value of 100 in column a. Even advanced query optimizers may not generally know this. Since the present method provides an accurate definition of the attribute value information, there is no need for performing assumptions such as (1) the values in the two columns are independent and (2) the number of rows is sufficiently large that the predicate on column a will not dramatically impact the value range of column b.

The present method may enable the query optimizer to exploit the extremum values from the attribute value information. The computer system may also be configured to systematically use the attribute value information at the execution time of queries in order to determine the data blocks of that table that must be scanned. For example, if the query optimizer does not provide a scan list as described herein then at the execution time the attribute value information may be used to determine the scan list, otherwise the scan list that is provided by the query optimizer may be used avoiding rebuilding it again at the execution time. The resulting scan list only contains data blocks that potentially contain matches for all query predicates, including combined and dependent predicates as in the above example query. For every data block, the smallest and largest column or attribute values are known—this information is directly available from the attribute value information. Using the smallest and largest column value across all data blocks in the actual scan list, as guaranteed lower and upper bound results e.g. the query cannot return smaller or larger values than these lower and upper bound results.

The present approach may be capable of outperforming the conventional approaches of query optimizers as it results in guaranteed upper and lower bounds. This may make it easy to combine with other methods: whatever method wins that proposes a larger minimum or smaller maximum. This way, the present approach may be capable of preventing massive outliers and misestimations. It could thus also be viewed as an additional safety net.

According to one embodiment, the set of query predicates comprise at least one of: inequality predicates. For example, the predicates of the received query may be compared with predefined set of predicates in order to select the set of query predicates as predicates that match the predefined predicates. This may provide an accurate method for identifying the set of query predicates which may in turn lead to better plan decisions and thus to further improved query performance. The set of query predicates may be evaluated using the attribute value information. For example the minimum and maximum values of a column or attribute may be useful for estimating predicates such as “column <constant” (or >, <=, >=) or anything that can be decomposed to one of these (e.g. LIKE ‘a %’ is decomposable to >=‘a’ AND <‘b’). The minimum and maximum values of a column or attribute may also be useful for estimating joins which requires to estimate the common values of both relations (i.e. tables). Put differently, it requires to estimate the amount of rows in the first table that are beyond the min/max range of the second table. For example if max(table A)<max(table B), then the rows in B that are >max(table A) will not find an equijoin partner. So it again comes to estimating “column >constant”, although this was not a query predicate of the original query.

According to one embodiment, the set of query predicates are related by an “AND” operation with each of the remaining predicates of the query. If there are remaining predicates in the query that cannot be evaluated using the attribute value information, those remaining predicates have to be in a specific relationship with the set of attributes such that the data blocks that are determined for evaluating the set of attributes can also be used to evaluate the remaining predicates. In other words, the set of query predicates may have a relationship with the remaining predicates such that the data blocks that are determined to evaluate the set of predicates can be used to evaluate the whole query. This may prevent evaluating the query on an underestimated or an incorrect scan list of data blocks, which may thus prevent wrong query results. For example, the set of query predicates may comprise predicate P1 and the remaining predicates are P2 and P3. In this case, a query comprising “P1 and (P2 OR P3)” may be evaluated using the present method, since parenthesis are encompassing the condition P1 OR P2, that condition can be considered as a single predicate which has to be with an “AND” operation with P1 in order to use the present method. However, it may not be beneficial to use the method for evaluating a query comprising P1 OR P2 AND P3, because the evaluation of P2 may require other data blocks than the data blocks required for evaluating P1.

According to one embodiment, if the set of query predicates are related with an “OR” operation with at least one of the remaining predicates of the query, providing the query execution plan using another predefined method for determining a query execution plan for the query. For example, if at least one query predicate of the set of query predicates is related with “OR” operation with another query predicate of the remaining query predicates. This embodiment may prevent skipping relevant data blocks to be scanned for evaluating the query.

According to one embodiment, the attribute value information are determined for the data blocks on a periodic basis. This may provide accurate extremum values may in turn lead to better plan decisions and thus to further improved query performance. For example, a query optimizer may generate statistics by a command like “RUNSTATS”. The generated statistics may comprise the extremum values that are computed or approximated for the data blocks as initially defined and stored in a given catalog. Those extremum values may be used as reference values for time dependent analysis of data evolution. The attribute value information may for example be updated by decreasing or increasing the minimum or maximum when a smaller or larger value is stored, respectively. Also, when rows containing extremum values are deleted, new extremum values may be recomputed for updating the attribute value information.

According to one embodiment, the method further comprises: determining reference values for the max and min values of each data block as the min and max values initially determined when the data blocks are created; comparing the smallest min value and the largest max value with corresponding values using the reference values, and updating the reference values if they are different. This may provide a cross check mechanism of validity of the reference values in particular as the reference values may be used for other purpose than the query planning.

According to one embodiment, the received query is a range query (or a query predicate) having an upper or lower boundary, the method further comprising: determining a selectivity value using the smallest min value and the largest max value, wherein the query optimization comprises estimating, based on the selectivity value, a cost of executing the query, the selectivity value comprising of:

$$\frac{x - {min}_{col}}{{max}_{col} - {min}_{col}} or \frac{{max}_{col} - x}{{max}_{col} - {min}_{col}} ,$$

where min_{col} and max_{col} are the smallest min value and the largest max value respectively, and x is the upper or the lower boundary. Using the selectivity which indicates the portion of the data table that satisfies the query range may increase the accuracy of the determined query planning.

According to one embodiment, the set of query predicates are executed against respective data tables.

According to one embodiment, the method is performed at query optimization time, the method further comprising maintaining the scan lists for query execution time. For example, the system may be prevented from the determination of the scan list at the execution time if the scan list is maintained (e.g. as part of the query plan). This may save processing resources that would otherwise be required by a re-determination of the scan list. Another advantage may be that the present method may seamlessly be integrated with existing systems e.g. systems where at the execution time the scan list has to be determined.

According to one embodiment, the set of the query predicates includes multiple predicates. This may enable query planning for complex queries.

According to one embodiment, the set of query predicates corresponds to a same attribute of the data table. This may provide a single dimension processing of attribute value information as well as query execution planning.

According to one embodiment, the query execution plan indicates at least one of a scan order and join order for the at least the data table based on the selectivity of the corresponding attribute.

According to one embodiment, the attribute value information further comprises an indication of the first record and the last record of the set of records, the set of records being contiguously stored.

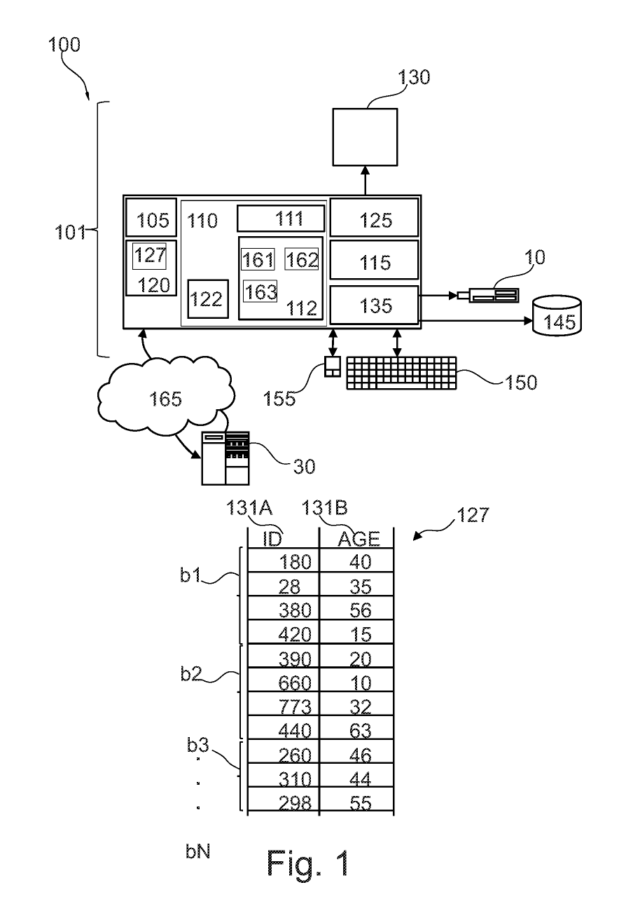

FIG. 1 represents a general computerized system, suited for implementing method steps as involved in the disclosure.

It will be appreciated that the methods described herein are at least partly non-interactive, and automated by way of computerized systems, such as servers or embedded systems. In exemplary embodiments though, the methods described herein can be implemented in a (partly) interactive system. These methods can further be implemented in software or instructions 112, 122 (including firmware 122), hardware (processor) 105, or a combination thereof. In exemplary embodiments, the methods described herein are implemented in software, as an executable program, and is executed by a special or general-purpose digital computer, such as a personal computer, workstation, minicomputer, or mainframe computer. The most general system 100 therefore includes a general-purpose computer 101.

In exemplary embodiments, in terms of hardware architecture, as shown in FIG. 1, the computer 101 includes a processor 105, memory (main memory) 110 coupled to a memory controller 115, and one or more input and/or output (I/O) devices (or peripherals) 10, 145 that are communicatively coupled via a local input/output controller 135. The input/output controller 135 can be, but is not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components. As described herein the I/O devices 10, 145 may generally include any generalized cryptographic card or smart card known in the art.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM). Note that the memory 110 can have a distributed architecture, where various components are situated remote from one another, but can be accessed by the processor 105.

The software in memory 110 may include one or more separate programs, each of which comprises an ordered listing of executable instructions for implementing logical functions, notably functions involved in embodiments of this invention. In the example of FIG. 1, software in the memory 110 includes instructions 112 e.g. instructions to manage databases such as a database management system.

The database management system or software 112 may comprise a parsing module 161 for parsing the query statements. Before a query statement such as, for example, a SQL statement is executed, the query statement needs to be “optimized”. For that, the database management system 112 may comprise an optimizer module or query optimizer 162 for generating an access or execution plan for received queries at the database management system 112.

Based on this execution plan, the execution engine 163 may define and scan the appropriate database rows and returns those that qualify back.

The processing time of a received query may comprise the parsing time that is spent by the parsing module, the optimization time that spent by the optimizer module and the execution time that is spent by the execution engine.

The software in memory 110 shall also typically include a suitable operating system (OS) 111. The OS 111 essentially controls the execution of other computer programs, such as possibly software 112 for implementing methods as described herein.

The methods described herein may be in the form of a source program or software 112, executable program or software 112 (object code), script, or any other entity comprising a set of instructions 112 to be performed. When a source program, then the program needs to be translated via a compiler, assembler, interpreter, or the like, which may or may not be included within the memory 110, so as to operate properly in connection with the OS 111. Furthermore, the methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 145 may include input devices, for example but not limited to a printer, a scanner, microphone, and the like. Finally, the I/O devices 10, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The I/O devices 10, 145 can be any generalized cryptographic card or smart card known in the art. The system 100 can further include a display controller 125 coupled to a display 130. In exemplary embodiments, the system 100 can further include a network interface for coupling to a network 165. The network 165 can be an IP-based network for communication between the computer 101 and any external server, client and the like via a broadband connection. The network 165 transmits and receives data between the computer 101 and external systems 30, which can be involved to perform part or all of the steps of the methods discussed herein. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) 122. The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software 112 stored within the memory 110, to communicate data to and from the memory 110, and to generally control operations of the computer 101 pursuant to the software. The methods described herein and the OS 111, in whole or in part, but typically the latter, are read by the processor 105, possibly buffered within the processor 105, and then executed.

When the systems and methods described herein are implemented in software 112, as is shown in FIG. 1, the methods can be stored on any computer readable medium, such as storage 120, for use by or in connection with any computer related system or method. The storage 120 may comprise a disk storage such as HDD storage.

The storage 120 may comprise at least one data table (or data set) 127. For example, the software 112 may receive (automatically or upon request) as input the data table 127, or may download the data table 127 from storage 120 or memory 110.

The data table 127 may comprise one or more columns 131A-B, wherein each column is represented by a respective attribute (e.g. “ID” 131A and “Age” 131B). The rows of the data table 127 may each comprise values of the attributes 131A-B. The data table 127 may for example comprise or may be stored on multiple (e.g. contiguous) data blocks b1-bN.

The term “data block” as used herein may refer to a logical or physical storage for storing the data of the data table.

For example, as illustrated in FIG. 1 the data table 127 may be divided or split or assigned to data blocks b1-bN using the number of rows in the data table 127.

In another example, the data table 127 may be split or divided based on storage size such that each data block b1-bN contains or is assigned to one or more storage units e.g. data pages. The term “storage unit” as used herein is intended to refer to the minimum addressable unit (e.g. by software 112) in order to store the data table 127. The size of a storage unit may be an integer multiple of the size of a disk unit. The size of the storage unit may be user defined. For example, each storage unit (e.g. data page) may correspond to a specific number of bytes of physical database space on disk (e.g., 4 KB). Other storage units having different granularities may be addressable or used in order to store data e.g. in the storage 120. For example, other storage levels may comprise containers and extents, wherein extents can be defined in term of number of data pages, while a container can determined in term of number of extents.

The rows of each data block e.g. b1 of the data table 127 may be stored on contiguous, linked, or indexed disk units (e.g. of storage 120) that form the corresponding data pages of the data block b1. The term disk unit refers to the minimum addressable unit on storage 120. For example, a disk unit may have a size of 512 bytes. The data blocks b1-bN may or may not comprise the same number of data pages.

The term “data table” or data set as used herein refers to a collection of data that may be presented in tabular form. Each column in the data table may represent a particular variable or attribute. Each row in the data table may represent a given member, record or entry of the data table.

Each data block b1-bN may be associated with attribute value information. For example, the attribute value information may be saved together with the data block to which it is associated (which is an indication that they both correspond to each other). In another example, the attribute value information may be stored (e.g. in a table) separately from the associated data block and having pointers/addresses or links to the associated data block.

While FIG. 1 only shows a few attributes and data blocks, it will be appreciated that numerous attributes and/or data blocks may exist or may be used.

A query that enters the system 100 is analyzed and the query predicates are extracted. For relational databases, the query predicates are assigned to the base table they act on. In this case, the following steps are performed for every base table separately.

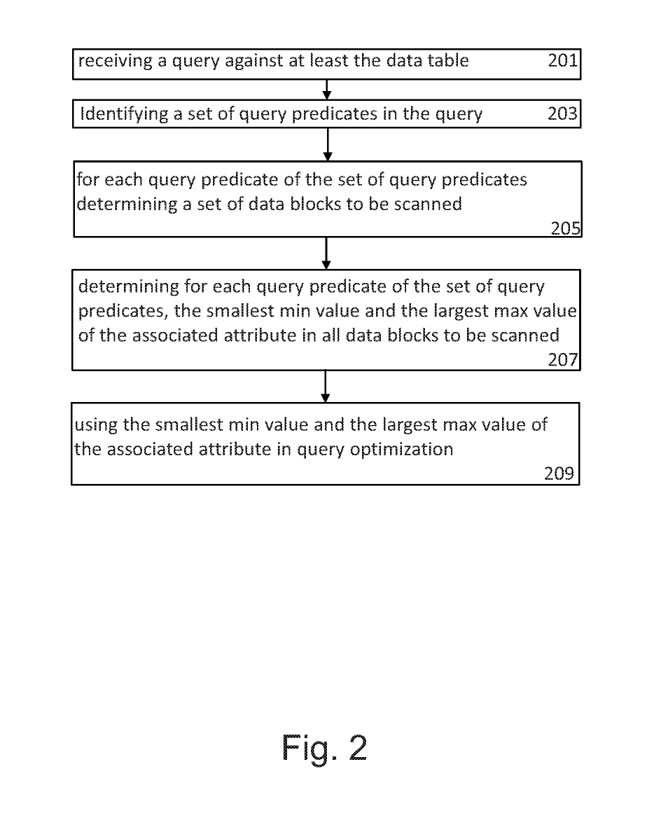

FIG. 2 is a flowchart of a method for preparing a query execution plan in a database management system e.g. 112.

In step 201, a query against at least the data table 127 may be received. The query contains query predicates associated with respective attributes 131A-B of the data table. The received query may comprise one or more query predicates each involving one or more attributes 131A-B of the data table 127. For example a first query predicate may involve attribute 131B and a second predicated may involve attribute 131A. In another example, the first query predicate and the second predicate may involve the same attribute.

A query predicate may be an element of a search condition that expresses or implies a comparison operation. For example, the query may comprise a statement for selecting rows of the data table 127 that meet specified criteria. The criteria may be expressed in the form of one or more predicates. For example, a query predicate may comprise an inequality predicate (e. g. “AGE <17”).

In step 203, a set of query predicates in the query that can be evaluated with the help of the attribute value information may be determined. The set of query predicates can be executed against the data table 127 and have associated attributes 131A-B.

For example, the parsing module 161 may parse the received query to identify the query predicates that can be evaluated using the attribute value information of the data blocks b1-bN.

In one example, query predicates of the received query may be identified as follows. The received query may be parsed to identify operators e.g. by comparing the operator of each selection expression in the query to a predefined list of operators that is e.g. stored on the computer 101. In another example, the query may be received from a user, wherein the received query further indicates the query predicates e.g. in addition to the query, a list of the predicates of the query may be received as well. The term “user” as used herein may refer to an entity e.g., an individual, a computer, or an application executing on a computer that inputs or issues the query.

Once the list of predicates of the received query is identified or determined, each of the predicates in the list may be checked or determined if it can be evaluated using the attribute value information. This may be performed by indicating for example, if the attribute value information are capable of telling whether a data block has guaranteed no rows that match the predicate. For example, predicates having the following operators: =, >, <, “column LIKE ‘abc %’” can be evaluated using the extremum values that are part of the attribute value information. However, predicates such as “attribute MOD 7=2” or “attribute LIKE ‘% xy’”, may not be evaluated using the attribute value information.

For example, to decide whether or not a given predicate is evaluable using the attribute value information, a hard-coded function can be used or a lookup-table like the following:
1) is the predicate in the form “attribute operator constant”
2) is operator among the supported ones?
3) (in case of LIKE) is the constant/pattern supported.

In another example, a predicate may be determined as being evaluable using the attribute value information using inputs from the user indicating that. For example, the query may be received together with information indicating the predicates of the query that can be evaluated using the attribute value information.

Most predicates may be evaluable using the attribute value information, but more complex (and possibly user-defined) functions, arbitrary pattern matching, modulo, among others, may not be. If predicates that are evaluable using the attribute value information are OR-ed with remaining predicates, then all data blocks must be scanned. However, if such predicates are AND-ed with the predicates that are evaluable using the attribute value information or all predicates are evaluable using the attribute value information, then the present approach may continue or may be applied.

In step 205, for each query predicate of the set of query predicates (determined in step 203) the attribute value information of the data table may be queried for determining a set of data blocks to be scanned. The set of data blocks may be the scan list for the each query predicate. If for example, a query predicate of the set of query predicates comprise the condition “AGE <17”, then data blocks b1 and b2 may be selected as the scan list since b3 is has attribute values of attribute “AGE” that are higher than 17 and thus no need for scanning data block b3.

This is may be advantageous as the scan list determined at the optimization time stage e.g. before the execution plan has been fully generated. The scan list may be kept until the query is executed later to avoid redefining the scan list by the execution engine 163. If the scan list has been kept (e. g., as a part of the query execution plan), then it may directly feed to a scan operator when the query is executed.

In step 207, for each query predicate of the set of query predicates, the smallest min value and the largest max value of the associated attribute in all data blocks to be scanned may be determined. The smallest min value and the largest max value may be guaranteed lower and upper bounds.

Using the above example, data block b1 has the attribute value information ([15 65]) indicating the minimum and the maximum values 15 and 65 of the attribute “AGE”, while data block b2 has the attribute value information ([10 63]) indicating the minimum and the maximum values 10 and 63 of the attribute “AGE”. In this case the smallest min value and the largest max value of the attribute “AGE” in all data blocks b1 and b2 are 10 and 65 respectively.

In other terms, the extremum values of all data blocks in the scan list are obtained from the attribute value information and are aggregated to the minimum and the maximum value of all data blocks that are actually scanned by this query. These are guaranteed lower and upper bounds.

In step 209, using the smallest min value and the largest max value of the associated attribute in query optimization, resulting in a query execution plan for the query.

The system 100 may possess at least one other heuristic to estimate the smallest min and the largest max values of a (part of a) query as a cross check of or in combination of the present method. These heuristics may be employed as well and the results combined with the extremum values obtained from the attribute value information (of step 207). The result is a more accurate estimate of the extremum values that can now be consumed by the cost model of the query optimizer.

Steps 205-209 may be performed during the optimization time.

In another example a method for preparing a query execution plan in a database management system is provided, where a data table involves a set of attributes and data records of the data table are stored in a set of data blocks, and attribute value information is provided for the data blocks, the attribute value information containing at least a min value representing the smallest value of at least one attribute and a max value representing the largest value of the at least one attribute. The method comprises: receiving a query against at least the data table, the query containing query predicates associated with respective attributes; determining a set of query predicates in the query that are evaluable using the attribute value information, the set of query predicates being executed against the data table and having associated attributes; querying for each query predicate of the set of query predicates the attribute value information of the data table for determining a set of data blocks to be scanned (the “scan lists”); determining, for each query predicate of the set of query predicates, the smallest min value and the largest max value of the associated attribute in all data blocks.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-14. (canceled)

15. A computer program product comprising a computer-readable storage medium having computer readable program stored therein for preparing a query execution plan in a database management system, wherein a data table comprising a set of attributes and data records is provided, attribute value information being provided for data blocks of the data table, the attribute value information comprising at least a minimum value representing the smallest value of at least one of the attributes in the set of attributes and a maximum value representing the largest value of the at least one attribute of the set of attributes, wherein the computer readable program, when executed on a computing device, causes the computing device to:
receive a query against the data table, the query comprising query predicates associated with respective attributes of the set of attributes;
determine a set of the query predicates in the query to evaluate using the attribute value information, the set of query predicates having associated attributes of the at least one attribute;
query, for each query predicate of the set of query predicates, the attribute value information of the data table for determining a set of the data blocks to be scanned;
determine, for each query predicate of the set of query predicates, the smallest minimum value and the largest maximum value of the associated attribute in all data blocks to be scanned; and
use the smallest minimum value and the largest maximum value of the associated attribute in query optimization, resulting in the query execution plan for the query.

16. The computer program product of claim 15, wherein the set of query predicates comprises at least one of inequality predicates or a query predicate from which an inequality predicate is derived.

17. The computer program product of claim 15, wherein the computer readable program for determining of the set of query predicates comprises, for at least one query predicate of the set of query predicates, further causes the computing device to:
provide patterns of query predicates to evaluate using the attribute value information;
parse the query into constituent parts;
determine that a constituent part parsed from the query corresponds to at least part of a pattern of the patterns; and
provide that constituent part as the query predicate.

18. The computer program product of claim 15, wherein the set of query predicates are related by an “AND” operation with each of the remaining predicates of the query not comprised in the set of predicates.

19. The computer program product of claim 15, wherein, responsive to the set of query predicates being related with an “OR” operation with at least one of the remaining predicates of the query, the computer readable program further causes the computing device to:
provide the query execution plan using a second method.

20. A computer system for preparing a query execution plan in a database management system, wherein a data table comprising a set of attributes and data records is provided, attribute value information being provided for data blocks of the data table, the attribute value information comprising at least a minimum value representing the smallest value of at least one of the attributes in the set of attributes and a maximum value representing the largest value of the at least one attribute of the set of attributes, the computer system comprising:
a processor; and
a memory coupled to the processor, wherein the memory comprises instructions which, when executed by the processor, cause the processor to:
receive a query against the data table, the query comprising query predicates associated with respective attributes of the set of attributes;
determine a set of the query predicates in the query to evaluate using the attribute value information, the set of query predicates having associated attributes of the at least one attribute;
query, for each query predicate of the set of query predicates, the attribute value information of the data table for determining a set of the data blocks to be scanned;
determine, for each query predicate of the set of query predicates, the smallest minimum value and the largest maximum value of the associated attribute in all data blocks to be scanned; and
use the smallest minimum value and the largest maximum value of the associated attribute in query optimization, resulting in the query execution plan for the query.

21. The computer system of claim 20, wherein the set of query predicates comprises at least one of inequality predicates or a query predicate from which an inequality predicate is derived.

22. The computer system of claim 20, wherein the instructions for determining of the set of query predicates comprises, for at least one query predicate of the set of query predicates, further cause the processor to:
provide patterns of query predicates to evaluate using the attribute value information;
parse the query into constituent parts;
determine that a constituent part parsed from the query corresponds to at least part of a pattern of the patterns; and
provide that constituent part as the query predicate.

23. The computer program product of claim 15, wherein the set of query predicates are related by an “AND” operation with each of the remaining predicates of the query not comprised in the set of predicates.

24. The computer system of claim 20, wherein, responsive to the set of query predicates being related with an “OR” operation with at least one of the remaining predicates of the query, the instructions further cause the processor to:
provide the query execution plan using a second method.

25. The computer system of claim 20, wherein the attribute value information is determined for the data blocks on a periodic basis.

26. The computer program product of claim 15, wherein the attribute value information is determined for the data blocks on a periodic basis.

27. The computer program product of claim 15, wherein the computer readable program further causes the computing device to:
determine as reference values smallest minimum value and the largest maximum value of the attribute in the data blocks when were initially created;
compare the smallest minimum value and the largest maximum value of the determining step with the reference values; and
update the reference values if they are different.

28. The computer program product of claim 15, wherein the received query is a range query having an upper or lower boundary and wherein the computer readable program further causes the computing device to;
determine a selectivity value using the smallest minimum value and the largest maximum value, wherein the query optimization comprises estimating, based on the selectivity value, a cost of executing the query, the selectivity value comprising of:
$$\frac{x - {min}_{col}}{{max}_{col} - {min}_{col}} or \frac{{max}_{col} - x}{{max}_{col} - {min}_{col}} ,$$
where min_{col} and max_{col} are the smallest minimum value and the largest maximum value respectively, and x is an upper boundary or a lower boundary.

29. The computer program product of claim 15, wherein the set of query predicates are executed against respective data tables.

30. The computer program product of claim 15, wherein the query execution plan indicates at least one of a scan order and join order for the at least the data table based on the selectivity of the corresponding attribute.

31. The computer program product of claim 15, wherein the computer readable program further causes the computing device to:
maintain scan lists for query execution time.

32. The computer program product of claim 15, wherein the set of the query predicates includes multiple predicates.

33. The computer program product of claim 15, wherein the set of query predicates corresponds to an attribute of the data table.

34. The computer program product of claim 15, wherein the attribute value information further comprises an indication of a first record and a last record of the set of records, the set of records being contiguously stored.
